(19) United States
(12) Patent Application Publication
(10) Pub. No.: US 2006/0070403 A1
(43) Pub. Date: Apr. 6, 2006

(54) Sol-gel method for producing a composite material provided with an lithium aluminosilicate vitroceramic matrix

(75) Inventors: Arnaud Tessier, Virandeville (FR); Philippe Toneguzzo, Chambray Les Tours (FR)

Correspondence Address: FOLEY AND LARDNER LLP;SUITE 500, 3000 K STREET NW, WASHINGTON, DC, 20007, US

(73) Assignee: Commissariat A L'Energie Atomique

(21) Appl. No.: 10/543,465

(22) PCT Filed: Sep. 22, 2004
(86) PCT No.: PCT/FR04/50453

§ 371 Date: Jul. 27, 2005

(30) Foreign Application Priority Data
Sep. 24, 2003 (FR) 0350600

(51) Int. Cl. C03B 8/00; B28B 1/00

(52) U.S. Cl. 65/17.2; 264/621; 65/33.8

(57) ABSTRACT

Method for preparing a composite comprising a fibre reinforcement and a glass-ceramic matrix essentially consisting of lithium aluminosilicate (LAS), the said method comprising the following successive steps: a) preparation of a sol of precursors of the matrix, comprising a lithium salt, a reactive binder containing alumina, colloidal silica and a solvent, and homogenization of the said sol; b) impregnation of the fibre reinforcement with the sol prepared in step a); c) drying of the impregnated fibre reinforcement, by means of which a gelled composite comprising a fibre reinforcement and a gelled matrix is obtained; and d) densification of the gelled composite of step c) at a temperature not exceeding 500° C.

### TECHNICAL FIELD

The invention relates to a method of preparing a composite by sol-gel processing, the said composite comprising a glass-ceramic matrix consisting essentially of lithium aluminosilicate or LiO₂—Al₂O₃—SiO₂ (LAS), and a fibre reinforcement.

The technical field of the invention may in general be defined as that of preparation and manufacture of ceramic matrix composites (CMCs) or glass-ceramic matrix composites with a fibrous reinforcement, more particularly ceramic or glass-ceramic matrix composites based on fibre-reinforced silica.

Such composites are used especially in the aeronautical and space industries owing to their good strength at medium or high temperatures of about 600 to 2500° C. They are also employed in the production of engine parts in the automobile industry.

Ceramic or glass-ceramic matrix composites, in particular fibre-reinforced silica-based composites, may be prepared by a variety of methods obeying various basic principles.

Thus, such composites may be prepared by a method based on the principle of preimpregnation followed by hot pressing. This method firstly consists in impregnating the fibres in a powder suspension. After drying, the fibres are stacked in a sequence of defined orientation and then introduced into a uniaxial press and hot-compressed generally at above 1000° C. so as to sinter them.

The pressing/sintering method does not allow parts of complex geometry to be obtained, for example parts including both positive and negative radii of curvature.

Ceramic matrix/fibre composites may also be prepared from gaseous precursors by the impregnation of fibrous preforms using the chemical vapour infiltration or CVI method.

This technique is limited by the low density of the products obtained, due to the closure of the pores, preventing access of the gas to the core of the material, and thereby preventing the continuation of the internal densification. Consequently, to optimize the impregnation, very slow, and consequently more expensive, deposition rates must be chosen.

Ceramic matrix composites may also be obtained by sol-gel processing. The principle of these methods consists in gelling a sol—that is to say a suspension in a liquid of particles having a size of less than 0.1 mm or a liquid formed from an organic or inorganic precursor and from a solvent—and in progressively creating a three-dimensional oxide lattice by a hydrolysis step followed by a precursor polymerization or condensation step.

What is thus obtained is a solid porous structure swollen with interstitial liquid, called gel, the backbone of which consists of more and more condensed species. A heat treatment, for drying and densifying this gel, then results in a ceramic material.

Methods for preparing ceramic matrix composites are described for example in the documents FR-A-2 655 327 and U.S. Pat. No. 5,126,087.

Document FR-A-2 655 327 relates to a method of preparing a glass-ceramic composition in which a gel is prepared by hydrolysis and polycondensation of metal precursor compounds dissolved in a solvent; removal of the solvent; optional milling of the gel thus obtained; dehydration and oxidation of the gel; further milling and screening so as to obtain a powder; and finally densification and ceramization.

The precursors used are tetraethyl orthosilicate Si(OC₂H₅)₄ (TEOS); aluminium sec-butylate Al(OCH(CH₃)CH₂H₅)₃ (ASB); lithium nitrate LiNO₃; and where appropriate magnesium nitrate Mg(NO₃)₂.6H₂O.

When it is desired to prepare a composite, a slip is prepared using the above powder and a viscous solution, for example a polymethyl methacrylate solution, and the reinforcement such as a fibre fabric is impregnated therewith.

The impregnated bands of fabric are stacked and then densified by a heat treatment at 1300° C. with pressing under a pressure of 11 MPa.

The precursors used in the method of that document, such as ASB, hydrolyse very readily and cure in the air—they therefore require the use of special equipment for processing them. Moreover, the production of a highly reactive powder of large specific surface area, by dehydration, oxidation and milling, constitutes an additional and demanding step.

Document U.S. Pat. No. 5,126,087 discloses a method of manufacturing a composite formed from a fibrous reinforcement and a silica-based ceramic or glass-ceramic matrix, in which a fibrous reinforcement is impregnated by means of a sol prepared from an aqueous silica solution, from a solution of a metal salt, such as aluminium nitrate or lithium nitrate, and from a solution containing a crystallization retarding agent, such as boric anhydride.

The fibrous reinforcement thus impregnated is dried and the impregnation and drying steps are repeated until a prepreg having the desired volume fraction of fibre is obtained. The prepreg is pyrolysed at a temperature ranging from 200 to 600° C. for a time long enough to remove the gases formed by the chemical reaction.

Finally, a hot pressing operation is carried out at 600 to 900° C. and at a pressure of less than 50 MPa, for example from 12.5 MPa to 25 MPa, followed by cooling with no pressure down to room temperature. A thermal post-treatment, called ceramization treatment, may be carried out at temperatures above the hot pressing temperature.

The method has the advantage over that described in document FR-A-2 655 327 of not requiring a step for drying and milling the gel, since the reinforcement is impregnated directly with an LAS-type sol and then densified.

However, the high-temperature densification of the fillers degrades certain fibres and this method of production also requires substantial infrastructures.

It follows from the foregoing that there exists a need, as yet not satisfied, for a lithium aluminosilicate glass-ceramic matrix composite preparation method, which is simple, inexpensive, reliable and easy to implement, which comprises a limited number of steps and which does not require complex and expensive apparatus and infrastructures.

There is also a need for a method of preparing a glass-ceramic matrix composite in which the said matrix is prepared from precursors that are easy to use, practically insensitive to moisture and to oxidation, and require no inert atmosphere for processing them.

There is also a need for a method of preparing a glass-ceramic matrix composite that uses relatively low temperatures, compatible with all types of reinforcement.

There is also a need for a method of preparing such a composite, in which the matrix is compatible with reinforcements of different geometries and sizes and made of different materials, in particular those of very complex geometries.

Finally, there exists a need for a method of preparing a glass-ceramic matrix composite which gives a material exhibiting excellent mechanical properties.

It is a goal of the present invention to provide a method of preparing a lithium aluminosilicate glass-ceramic matrix composite that meets inter alia the abovementioned requirements.

Another goal of the present invention is to provide such a method, which does not have the drawbacks, defects, limitations and disadvantages of the methods of the prior art and which solves the problems of the methods of the prior art.

These goals, and yet others, are achieved according to the invention by a method for preparing a composite comprising a fibre reinforcement and a glass-ceramic matrix essentially consisting of lithium aluminosilicate (LAS), the said method comprising the following successive steps:

a) preparation of a sol of precursors of the matrix, comprising a lithium salt, a reactive binder containing alumina, colloidal silica and a solvent, and homogenization of the said sol;

b) impregnation of the fibre reinforcement with the sol prepared in step a);

c) drying of the impregnated fibre reinforcement, by means of which a gelled composite comprising a fibre reinforcement and a gelled matrix is obtained; and

d) densification of the gelled composite of step c) at a temperature not exceeding 500° C.

Advantageously, the final glass-ceramic matrix consisting essentially of lithium aluminosilicate has the composition xLiO₂-yAl₂O₃-zSiO₂, where x ranges from 1 to 2, y ranges from 1 to 2 and z ranges from 1 to 4.

Advantageously, the sol comprises by weight: from 1 to 4% of lithium salt, from 15 to 25% of alumina-containing reactive binder and from 30 to 50% of colloidal silica.

Advantageously, the lithium salt is chosen from lithium halides (fluorides, chlorides, iodides and bromides) and lithium nitrate.

Advantageously, the solvent for the sol is chosen from water, ethanol and mixtures thereof.

Advantageously, the sol furthermore contains one or more additional precursors chosen from metal oxides and mica.

Advantageously, the said metal oxides are chosen from MgO, ZrO₂ and TiO₂.

Advantageously, the said additional precursors are added so as to each represent from 0.1 to 2% by weight of the matrix.

Advantageously, the fibres of the reinforcement comprise one or more elements chosen from Si, B, O, N and C.

Advantageously, the reinforcement fibres are chosen from glass fibres, carbon fibres, silicon carbide fibres, alumina-silica fibres, alkaline-earth silicate fibres and metal wires sheathed with an electrical insulator, for example glass-sheathed copper wires.

Advantageously, the fibre reinforcement is in the form of a fabric; a fibre paper, such as the product sold under the name SUPERWOOL PAPER X607 from Sored-UPM; or a non-woven web or fleece of fibres.

Advantageously, the fibre reinforcement is in the form of a stack of several layers, thicknesses or plies.

Advantageously, the layers, thicknesses or plies differ in their composition and/or their structure and/or their properties, for example magnetic and/or electrical and/or optical and/or mechanical properties.

Advantageously, the fibrous reinforcement is placed in or on a preform or mould.

Advantageously, the impregnation of step b) is carried out using a brush or by dipping.

Advantageously, this drying is carried out in a vacuum or under pressure.

It may be carried out in an oven, a vacuum bag or in the open air.

Advantageously, the drying is carried out at a temperature of 70 to 180° C. The drying temperature is advantageously maintained for a period of 1 to 4 hours.

Advantageously, the drying temperature is reached by raising the temperature from room temperature at a rate of 1 to 4° C./minute.

Advantageously, the gelled matrix represents from 15 to 25% by weight of the composite.

The impregnation and drying steps may be repeated from one to three times until the composite has the desired weight content of gelled matrix.

Advantageously, the densification of step d) is carried out at a temperature of 350 to 600° C.

The densification temperature is advantageously maintained for a period of 1 to 5 hours and the densification temperature is advantageously reached by raising the temperature from room temperature at a rate of 1 to 5° C./minute.

The method according to the invention differs fundamentally from the methods of the prior art using sol-gel processing, such as those described in the abovementioned documents.

This is because the matrix is produced from readily available, inexpensive and easily processible precursors, which can be handled in the open air and not necessarily under a stream of nitrogen, as is the case for certain alkoxide-type precursors such as those mentioned in document FR-A-2 655 327, which hydrolyse and cure in the open air.

Moreover, the method of the invention involves no hot uniaxial pressing step as in document U.S. Pat. No. 5,126,087, by making it possible to design parts having a complex geometry. Furthermore, the densification temperature used in the method of the invention is low, namely 500° C. or lower, this being substantially below the 900° C., under pressure, of the above document.

The method according to the invention makes use of simple and inexpensive equipment and processing means, and it comprises a limited number of steps, which are themselves simple, inexpensive and easy to implement.

Thus, the sol is prepared as already mentioned above from precursors that require no precautions when using them. The sol produced is immediately ready to be injected into the reinforcement, and it gels in the core of the reinforcement during the drying step. In the method of the invention, the step of dehydrating and milling the gel, essential in the method of document FR-A-2 655 327, is unnecessary, thereby greatly simplifying the method. The specific sol used in the method of the invention is very easy to use and the impregnation may be carried out by any known technique and especially very simply using a brush or by dipping.

The sol and the matrix prepared from it are compatible with fibres of very different composition and shape.

It is therefore possible with the method of the invention to produce, for example, laminates formed from plies or thicknesses of different chemical nature.

Thus, the fibres used may contain the elements Si, B, O, N or C, and the fibres used may for example be in fabric or fibre form.

The specific matrix according to the invention is highly reactive and the chemical adhesion between the matrix and the fibres, and possibly between the various layers of the composite, is also very rapid. Mechanical adhesion generated by hot uniaxial pressing is therefore, according to the invention, no longer necessary. This makes it possible to prepare parts with a complex geometry, which could not be prepared by the methods of the prior art.

One of the essential features of the method of the invention is the low densification temperature of the composite, and more particularly of the matrix. This is because, thanks to the method of the invention, it is possible to obtain a bulk material at a temperature not exceeding 500° C. This low glass-ceramic densification temperature makes it possible to carry out shorter heat treatment cycles and thus subject the fibrous reinforcements to markedly lower stresses.

Consequently, in the method of the invention it is possible to combine the specific matrix according to the invention with fibrous reinforcements that would not have withstood the very high densification temperature commonly used in the methods of the prior art.

To summarize, the method according to the invention essentially consists in preparing a specific sol comprising a specific composition based on commercially available precursors, which gives a specific and very reactive matrix, highly compatible with all kinds of fibres, and which can be densified at a low temperature.

The invention will now be described in detail in the following description given by way of illustration, but implying no limitation, and with reference to the appended drawings, in which:

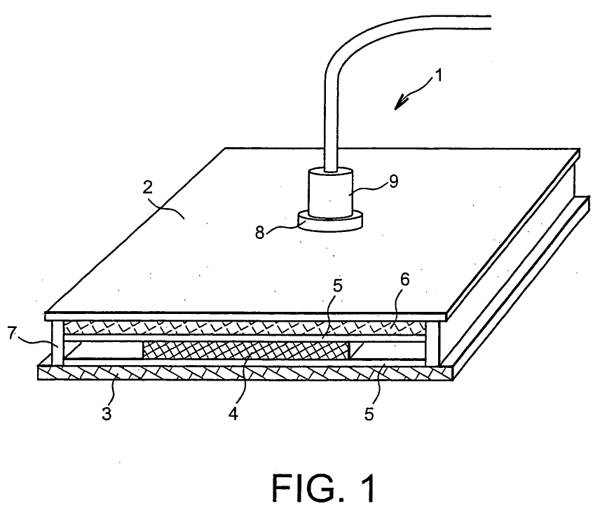

FIG. 1 is a schematic perspective view of a vacuum bag used in the drying step of the method of the invention;

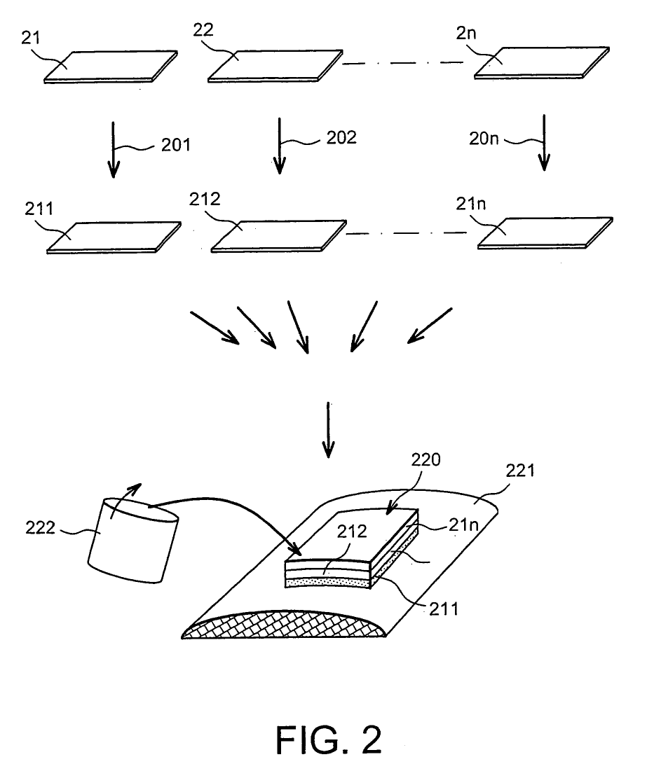

FIG. 2 is a diagram showing the preparation, using the method of the invention, of a composite comprising a “sandwich”, laminated fibrous reinforcement formed from n layers or plies; and

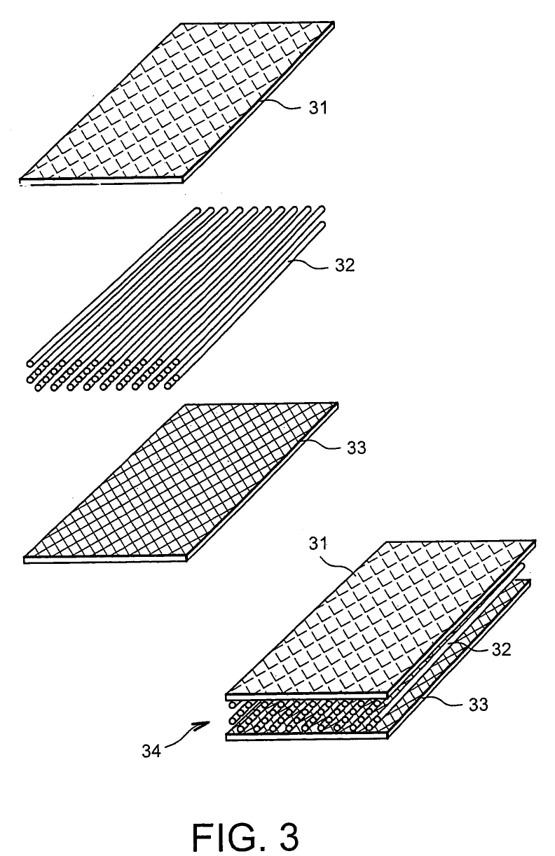

FIG. 3 is a schematic perspective view showing the preparation, using the method of the invention according to Example 2, of a laminate from a layer of Nextel®312 fabric, a layer of metal wires sheathed in Pyrex® glass and a layer of carbon fabric.

In detail, the method according to the invention comprises firstly a step of preparing a sol from the precursors of the matrix of the composite, which comprises a lithium salt, an alumina-containing reactive binder and a solvent.

The term “reactive binder” is understood in general to mean that the constituents of this binder, other than alumina, are capable of reacting in order to form a polymeric gel. The reactive binder may therefore comprise reactive inorganic monomers and the alumina filler. Such reactive inorganic monomers are chosen for example from metal alkoxides.

The sol is generally prepared by mixing an aqueous suspension of colloidal silica, an acid aqueous suspension of alumina and lithium salts.

These precursors are commercially available lithium, aluminium and silica precursors.

Thus, the colloidal silica suspension is for example a suspension sold under the name LUDOX HS40 by DuPont de Nemours (composition: 40% SiO₂ by weight; specific surface area: 198 to 258 m²/g; dispersed in a basic aqueous solution).

The acid alumina suspension is for example a suspension sold under the name Binder 795 by Cotronics Corporation, this being an alumina suspension in an acid aqueous medium.

The lithium salt is generally chosen from lithium halides and lithium nitrate. One particularly preferred salt is lithium nitrate.

A solvent, generally chosen from water, ethanol and mixtures thereof, is added to this suspension.

A preferred solvent is demineralized water. The precursors react with the added solvent, such as demineralized water, to give the sol of step a). The solvent promotes the hydrolysis of the sol. The nature of the solvent and the degree of dilution of the sol also play a role in the dilution of the salts. The solvent also allows the viscosity of the sol to be modified and therefore allows easier impregnation of the sol into the fibrous reinforcement.

The impregnated sol generally comprises, by weight, 1 to 4% lithium salt, 15 to 25% alumina-containing reactive binder and 30 to 50% silica.

The molar ratios of the various precursors are such that the final LAS matrix (after densification) has a composition xLiO₂-yAl₂O₃-ZSiO₂, where x, y and z, which represent the molar ratios in the matrix of oxides that are formed, are such that 1≦x≦2, 1≦y≦2 and 1≦z≦4. These molar ratios are adjusted according to the intended application.

Other additional fillers or precursors may be added to the sol.

These fillers are generally chosen from metal oxides, such as MgO, ZrO₂ and TiO₂, and mica.

These additional fillers or precursors are used to modify certain characteristics of the matrix. Thus, adding fillers such as mica improves the temperature resistance and limits the propagation of cracks into the composite. The additional fillers or precursors are generally added to the sol in proportions (for each of them) of 0.1 to 2% by weight (of the sol).

Finally, the sol is homogenized by mechanical or magnetic stirring, for example using a suitable apparatus such as a magnetic stirrer, like the apparatus sold under the name HEIDOLPH-NR 2002.

The next step of the method of the invention is the impregnation of the fibrous reinforcement with the sol prepared in the step described above.

The sol and the matrix obtained from it are compatible with fibres of different nature, for example these fibres may be formed from the chemical elements Si, C, N, O, B, by themselves or as mixtures. The chemical composition of the fibres employed may differ depending on the envisaged use.

As examples of fibres that can be used in the method of the invention, mention may be made of glass fibres, carbon fibres, silicon carbide fibres and alumina-silica, alumina-silica-boron oxide or alkaline-earth silicate fibres.

Also included in the fibres according to the invention are wires, for example metal wires such as copper wires sheathed with an electrical insulator, for example glass and in particular Pyrex®.

Moreover, the fibres used may be unidirectional and continuous, or else, as mentioned above, they may be in the form of wires.

The fibre reinforcement may be in the form of 2D or 3D fabrics; fibre papers; webs, for example unidirectional webs, or fleeces, for example unidirectional fleeces; or other non-woven fibre materials; or else multidirectional preforms.

The fabrics may especially be taffetas or satins.

The fibres used in the method of the invention are generally what are called long fibres, that is to say their length is generally from 3 to 100 cm.

The fibrous reinforcement may be formed by a stack, superposition or laminate of layers of the same chemical composition or nature and of the same structure, or else layers of different chemical composition or nature and/or of different structure and/or properties, for example magnetic and/or electrical and/or optical and/or mechanical properties.

It should be noted that, before its use, the fibrous reinforcement generally undergoes a thermal or chemical desizing treatment. It will be recalled that the size is an organic coating on the monofilament used for manufacturing industrial fabrics, which coating ensures that the fibres can slide relative to one another and avoids premature wear of these fibres.

A thermal desizing treatment may for example consist in heating the fabric in air to 500 to 700° C.

A chemical desizing treatment may for example consist in dipping the fibres into a solvent or a solvent mixture, for example an acetone/ethanol mixture, for example for a minimum period of 10 hours.

The fibrous reinforcement, for example in the form of a fabric or a stack of fabrics, or the like, is positioned on a preform, or placed in a mould, the shape of the preform or mould corresponding to the shape of the final part that it is desired to produce.

The preform or mould may, according to the method of the invention, coat even very complex shapes, for example cylindrical shapes.

Furthermore, it is possible with the method of the invention to manufacture parts of large size, for example a size ranging from 1 to 3 m².

The next step of the method according to the invention consists in impregnating the fibrous reinforcement with the sol prepared above.

The impregnation of the fibrous reinforcement may be carried out by any suitable method.

This impregnation may therefore be carried out, for example, using a brush or by dipping.

These methods are methods that are extremely easy to implement using limited equipment.

The next step of the method of the invention is a step of drying the impregnated fibrous reinforcement. The drying step may be carried out in the open air or in an oven.

The drying may also be carried out either at atmospheric pressure or under a slight pressure, for example 1 to 4 bar, by placing a weight on the impregnated fibrous reinforcement, or else in a vacuum bag at a pressure of 0.5 to 1 bar; in both cases, the fibrous reinforcement is heated in an oven.

By applying a vacuum or pressure it is possible in particular to increase the affinity between the various plies or thicknesses that make up the fibrous reinforcement.

A vacuum bag that can be used for drying the impregnated fibrous reinforcement is described in FIG. 1.

The vacuum bag (1) comprises a vacuum application sheet (2) forming the upper wall of the bag, a preform (3) forming the lower wall, on which the impregnated fibrous reinforcement (4) is placed, a separator sheet (5) placed above and below the impregnated fibrous reinforcement, a drainage fabric (6) placed between the vacuum application sheet and the upper separator sheet, and finally a flexible mastic (7) that defines the side walls between the said preform (3) and the said vacuum application sheet (2).

The vacuum application sheet (2) is penetrated, for example at its centre, by an orifice (8) connected to a suction nozzle (9), allowing a partial vacuum to be created in the vacuum bag.

The drying is generally carried out by maintaining a temperature of 70 to 180° C. during a period of 1 to 4 hours, for example a temperature of 180° C. for a period of 4 hours.

Preferably, the temperature rise in order to reach the drying temperature is a slow rise, for example performed at a rate of 1 to 4° C./minute.

After this drying step, a gelled composite comprising the fibre reinforcement and a gelled matrix is obtained.

The gelled matrix generally represents from 15 to 25% by weight of the gelled composite obtained from the drying step carried out a first time. In general, the composite has a fibre volume fraction of 0.5 to 0.7 after a drying operation.

The impregnation and then drying steps may be repeated, for example from one to three times, until a composite is obtained that has the desired content of gelled matrix, for example 15 to 25% by weight, or the desired volume fraction of fibres, for example 0.5 to 0.7.

The gelled composite (the impregnated and dried composite) is then densified by a heat treatment called a densification treatment. The densification is generally carried out at a temperature of 350 to 600° C., for example of 500° C., maintained for a period of 1 to 5 hours, for example 1 hour.

The densification temperature is generally reached by raising the temperature from room temperature at a rate of 1 to 5° C./minute, for example 1° C./minute, until the densification hold temperature is reached.

It should be noted that, according to the invention, this temperature of the final heat treatment or densification treatment is much lower than that reached in the methods of the prior art, and consequently the energy expended in the method of the invention is substantially less than that in the methods of the prior art.

After densification heat treatment, the densified composite, brought back beforehand to room temperature, is demoulded or separated from the preform that served to produce it. The composite is then ready to be used.

The composite prepared by the method according to the invention exhibits excellent properties, in particular it has in general a less rigid, more flexible and less brittle texture than the composites of the prior art, which may be advantageous for certain uses, in particular in the form of a non-structuring coating.

FIG. 2 illustrates the preparation, using the method of the invention, of a composite comprising a fibrous reinforcement, this being a particular, laminated or sandwich, fibrous reinforcement formed from n layers, plies or thicknesses.

A method starts, as shown in FIG. 2, with the desizing (201, 202, . . . , 20n) of each of the layers or plies 21, 22, . . . , 2n by means of which n desized layers or plies 211, 212, . . . , 21n are obtained. Next, the n layers or plies are stacked on the preform (the mould), this being shown in FIG. 2 as having the shape of a tile.

Thus, a sandwich (220) comprising n plies or layers placed on the preform (221) is obtained.

This sandwich is impregnated with a sol (222) having the desired composition, for example as described above. Next, the drying treatment is carried out, followed by the final heat treatment as defined above.

The composites produced by the method of the invention have many applications.

The composites produced, prepared according to the invention, may be used in particular for the manufacture of parts that have to withstand high mechanical stresses, whether in bending-tension and/or in vibration, in a harsh environment, for example, a high temperature and/or oxidizing atmosphere. These parts may be applicable in a variety of sectors, such as:
aeronautics;
motor vehicles;
buildings.

The composites prepared according to the invention that have a sandwich structure offer the possibility of combining individual layers, each having particular optical and/or magnetic and/or electrical properties.

Owing to its good temperature resistance, the composite may for example be used for producing engine cowlings or lightweight fire-resistant partitions.

The invention will now be described with reference to the following examples, given by way of illustration but implying no limitation.

### EXAMPLES

### Example 1

In this example, a part made of a composite having the shape of a sheet with the dimensions 50 mm×50 mm and a matrix consisting of SiO₂, Al₂O₃ and LiO₂, was prepared.

A sol containing 3.3 g of LiCl, 6.5 g of a commercially available alumina-containing ceramic binder (Binder 795, consisting of alumina dispersed in an acid aqueous medium, from Cotronics Corporation) and 20 g of colloidal silica (LUDOX HS 40 from DuPont de Nemours) was diluted in 15.5 g of demineralized water then homogenized by magnetic stirring for 15 minutes at room temperature.

The fibrous reinforcement used was a silicon carbide (SiC) fabric desized by dipping it into an equimolar mixture of acetone and ethanol for 24 hours. SiC tapes were cut to the dimensions of the part and then positioned on a mould in the form of the part, in order to match the contours thereof (shape: 50 mm×50 mm in plan and 3 mm in thickness).

Using a brush, the desized fabric was impregnated with the above sol, which formed the ceramic matrix. The impregnated composite was then dried for 4 hours in an oven at 180° C.

To obtain a matrix mass fraction of 20%, it was necessary to repeat the impregnation-drying cycle.

After these two impregnation-drying cycles, the composite was ceramized (fired) for 1 hour at 500° C.

### Example 2

The composite produced in this example was a coating in the form of a sandwich (34) comprising three layers, plies or thicknesses of different nature.

The matrix used for this sandwich was similar to that used in Example 1, that is to say an LAS.

The three plies, thicknesses or layers of different nature making up the reinforcement were the following: the first ply or top ply (31) was an alumina-silica-boron oxide fabric (Nextel® 312) thermally desized at 700° C. for 1 hour; the second ply or central ply (32) was a web of pyrex-sheathed metal wires; and, finally, the bottom ply was a carbon fabric.

This carbon bottom layer (33) was used to enhance the chemical affinity between this part and the carbon substrate and therefore to make it easier to bond the composite. The various fabrics were impregnated by dipping them into the sol, and they were then stacked so as to form the sandwich.

This sandwich was placed in a hermetically sealed vacuum bag and then placed in an oven for the drying step, at 180° C. for 4 hours. The vacuum bag was permanently pumped so as to remove the solvent and to apply a constant compressive force.

After being dried, the sandwich was removed from the vacuum bag and then densified by heat treatment that included a step at an isothermal hold temperature for 1 hour at 500° C.

### Example 3

A sol made up from 3.3 g of LiCl, 6.5 g of a commercially available ceramic binder containing aluminium oxides, 20 g of colloidal silica and 10 g of mica was prepared.

The viscosity of the sol was adjusted using 23 g of demineralized water.

After being vigorously stirred (with a HEIDOLPH NR 2002 magnetic stirrer), the sol was injected into a flexible fibrous reinforcement sold under the name “alkaline-earth silicate fibre paper” (SUPERWOOL PAPER X607 from Sored-UPM).

After having been dried for 4 hours at 180° C. and then densified at 500° C. for 1 hour, this composite was able to be used as an insulating seal.

### Example 4

To prepare a composite sheet that acts as a heat shield, a sol was produced from 3.3 g of LiCl, 6.5 g of commercially available ceramic binder containing aluminium oxides, 20 g of colloidal silica, 15.5 g of demineralized water and 9 g of TiO₂ powder. The titanium oxide gave the fabric a very white colour.

A stack of three layers of Nextel® 312 (AF40) fabric was impregnated with the sol thus prepared, and then dried in a vacuum bag similar to that given in Example 2. After having been dried, the stacks forming sandwich panels were removed from the vacuum bag and then placed in an oven in order to undergo a heat treatment of 2 hours at 500° C.

1-28. (canceled)

29. A method for preparing a composite comprising a fiber reinforcement and a glass-ceramic matrix consisting essentially of lithium aluminosilicate, said method comprising the following successive steps:
a) preparation of a sol of precursors of the matrix, comprising a lithium salt, a reactive binder containing alumina, colloidal silica and a solvent, and homogenization of the said sol;
b) impregnation of a fiber reinforcement with the sol prepared in step a);
c) drying of the impregnated fiber reinforcement, by means of which a gelled composite comprising a fiber reinforcement and a gelled matrix is obtained; and
d) densification of the gelled matrix of step c) at a temperature not exceeding 500° C.

30. The method according to claim 29, in which the glass-ceramic matrix consists essentially of lithium aluminosilicate has the composition xLiO₂-yAl₂O₃-zSiO₂, where x ranges from 1 to 2, y ranges from 1 to 2 and z ranges from 1 to 4.

31. The method according to claim 29, wherein the sol comprises by weight: from 1 to 4% of lithium salt, from 15 to 25% of alumina-containing reactive binder and from 30 to 50% of colloidal silica.

32. The method according to claim 31, wherein the lithium salt is selected from the group consisting of lithium halides and lithium nitrate.

33. The method according to claim 29, wherein the solvent is selected from the group consisting of water, ethanol and mixtures thereof.

34. The method according to claim 29, wherein sol furthermore comprises one or more additional precursors selected from the group consisting of from metal oxides and mica.

35. The method according to claim 34, wherein said metal oxides are selected from the group consisting of MgO, ZrO₂ and TiO₂.

36. The method according to claim 34, wherein said additional precursors are added so as to each represent from 0.1 to 2% by weight of the matrix.

37. The method according to claim 29, wherein the fiber reinforcement comprises one or more elements selected from the group consisting of Si, B, O, N and C.

38. The method according to claim 37, wherein the reinforcement fibres are selected from the group consisting of glass fibers, carbon fibers, silicon carbide fibers, alumina-silica fibers, alumina-silica-boron oxide fibers, alkaline-earth silicate fibers and metal wires sheathed with an electrical insulator, such as glass-sheathed copper wires.

39. The method according to claim 29, wherein the reinforcement fibers are unidirectional and continuous, or are in the form of wires.

40. The method according to claim 29, wherein the fiber reinforcement is in the form of a 2D or 3D fabric selected from the group consisting of taffeta or satin, a fibre paper, a web or fleece which is optionally unidirectional, or optionally comprised of another non-woven fiber material, or optionally a multidirectional preform.

41. The method according to claim 29, wherein the fibers have a length from 3 cm to 100 cm.

42. The method according to claim 29, wherein the fiber reinforcement is in the form of a stack of several layers, thicknesses or plies.

43. The method according to claim 42, in which the layers, thicknesses or plies differ in their composition and/or their structure and/or their properties.

44. The method according to claim 43, wherein the different properties are selected from the group consisting of magnetic and/or electrical and/or optical and/or mechanical properties.

45. The method according to claim 29, wherein the fibrous reinforcement is placed in or on a preform or mould.

46. The method according to claim 29, wherein the impregnation of step b) is carried out using a brush or by dipping.

47. The method according to claim 29, wherein the drying is carried out in a vacuum.

48. The method according to claim 29, wherein the drying is carried out under pressure.

49. The method according to claim 29, wherein the drying of step c) is carried out in an oven, a vacuum bag or in the open air.

50. The method according to claim 29, wherein the drying is carried out at a drying temperature of 70 to 180° C.

51. The method according to claim 50, wherein the drying temperature is maintained for a period of 1 to 4 hours.

52. The method according to claim 50, wherein the drying temperature is reached by raising the temperature from room temperature at a rate of 1 to 4° C./minute.

53. The method according to claim 29, wherein the gelled matrix represents from 15 to 25% by weight of the composite.

54. The method according to claim 29, wherein the impregnation and drying steps are repeated from one to three times until the composite has the desired weight content of gelled matrix.

55. The method according to claim 29, wherein the densification of step d) is carried out at a temperature of 350 to 600° C.

56. The method according to claim 55, wherein the densification temperature is maintained for a period of 1 to 5 hours.

57. The method according to claim 56, wherein the densification temperature is reached by raising the temperature from room temperature at a rate of 1 to 5° C./minute.
